(19) United States
(12) Patent Application Publication
(10) Pub. No.: US 2012/0136544 A1
(43) Pub. Date: May 31, 2012

(54) METHOD AND SYSTEM FOR CONTROLLING VEHICLE SHIFTING

(75) Inventor: Man Se Heo, Hwaseong-si (KR)

(73) Assignee: Hyundai Motor Company, Seoul (KR)

(21) Appl. No.: 13/188,206

(22) Filed: Jul. 21, 2011

(30) Foreign Application Priority Data
Nov. 29, 2010 (KR) 10-2010-0119811

(51) Int. Cl. F16H 61/02

(52) U.S. Cl. 701/56

(57) ABSTRACT

A method and a system for controlling vehicle shifting is configured to change shift patterns by reflecting a driver's shifting habits. The method may include running the vehicle according to a first shift pattern, detecting control parameters, determining whether the detected control parameters satisfies a first shift pattern conversion condition, and running the vehicle according to a second shift pattern when the first shift pattern conversion condition is satisfied.

### CROSS-REFERENCE TO RELATED APPLICATION

The present application claims priority of Korean Patent Application Number 10-2010-0119811 filed Nov. 29, 2010, the entire contents of which application is incorporated herein for all purposes by this reference.

### BACKGROUND OF THE INVENTION

1. Field of the Invention

The present invention relates to a control method of an automatic transmission. More particularly, the present invention relates to a method and a system for controlling vehicle shifting which changes shift pattern by reflecting a driver's shifting habits.

2. Description of the Related Art

Generally, an automatic transmission automatically performs shift to a target shift-speed according to running state of a vehicle. Such the shift is performed by a predetermined shift pattern, not by a driver's shifting habits.

A plurality of upshift lines and downshift lines which define boundaries between shift-speeds is provided in the shift pattern. If the running state of the vehicle is changed to cross the upshift line the automatic transmission performs upshift, and if the running state of the vehicle is changed to cross the downshift line the automatic transmission performs downshift. Therefore, if the running state of the vehicle is changed so as to cross the upshift line or the downshift line, shift occurs regardless of a driver's shifting habits.

The shift pattern is closely related to driving torque of the vehicle and fuel economy. For example, if upshift is done at a low vehicle speed and the vehicle runs at a high shift-speed, fuel consumption may be reduced and accordingly fuel economy may be improved. Therefore, a fuel economy oriented shift pattern which allows a shift at a low vehicle speed is set in most of vehicles for enhancement of fuel economy.

However, some drivers complain about the fuel economy oriented shift patterns. That is, since shift to higher shift-speed occurs early according to the fuel economy oriented shift pattern, the sense of acceleration may deteriorate when accelerating.

In addition, the upshift line is positioned at higher speed than the downshift line in the shift pattern so as to prevent frequent shifting. If the upshift line is positioned at a low speed for improving fuel economy, the downshift line is positioned at a lower speed and thus acceleration after tip-out does not occur well.

The information disclosed in this Background section is only for enhancement of understanding of the general background of the invention and should not be taken as an acknowledgement or any form of suggestion that this information forms the prior art already known to a person skilled in the art.

### BRIEF SUMMARY

The present invention has been made in an effort to provide a method and a system for controlling vehicle shifting having advantages of changing shift pattern to an acceleration oriented shift pattern by reflecting a driver's shifting habits.

A method for controlling vehicle shifting according to an exemplary embodiment of the present invention may include running the vehicle according to a first shift pattern, detecting control parameters, determining whether the detected control parameters satisfies a first shift pattern conversion condition, and running the vehicle according to a second shift pattern when the first shift pattern conversion condition is satisfied.

The first shift pattern conversion condition may be satisfied when a position value of an accelerator pedal is larger than or equal to a predetermined position value, and a position change of the accelerator pedal is larger than or equal to a predetermined position change.

The method may further include detecting the control parameters during running the vehicle according to the second shift pattern, determining whether the detected control parameter satisfies a second shift pattern conversion condition, and running the vehicle according to the first shift pattern when the second shift pattern conversion condition is satisfied.

The second shift pattern conversion condition may be satisfied when the vehicle is stopped or a position of a shift lever is P, R, or N range.

A system for controlling vehicle shifting according to another exemplary embodiment of the present invention may include an accelerator pedal position sensor detecting a position of an accelerator pedal, a shift lever position sensor detecting a position of a shift lever, a vehicle speed sensor detecting a vehicle speed, and a control portion operatively connected to the accelerator pedal position sensor, the shift lever position sensor, and the vehicle speed sensor, and controlling vehicle shifting, wherein the control portion runs the vehicle according to a first shift pattern at an initial state, and runs the vehicle according to a second shift pattern when a first shift pattern conversion condition is satisfied.

The first shift pattern conversion condition may be satisfied when a position value of an accelerator pedal is larger than or equal to a predetermined position value, and a position change of the accelerator pedal is larger than or equal to a predetermined position change.

The control portion may run the vehicle according to the first shift pattern when a second shift pattern conversion condition is satisfied during running the vehicle according to the second shift pattern.

The second shift pattern conversion condition may be satisfied when the vehicle is stopped or a position of a shift lever is P, R, or N range.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a block diagram of an exemplary system for controlling vehicle shifting according to the present invention.

FIG. 2 is a flowchart of an exemplary method for controlling vehicle shifting according to the present invention.

FIG. 3 illustrates comparison of a fuel economy oriented shift pattern and an acceleration oriented shift pattern.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

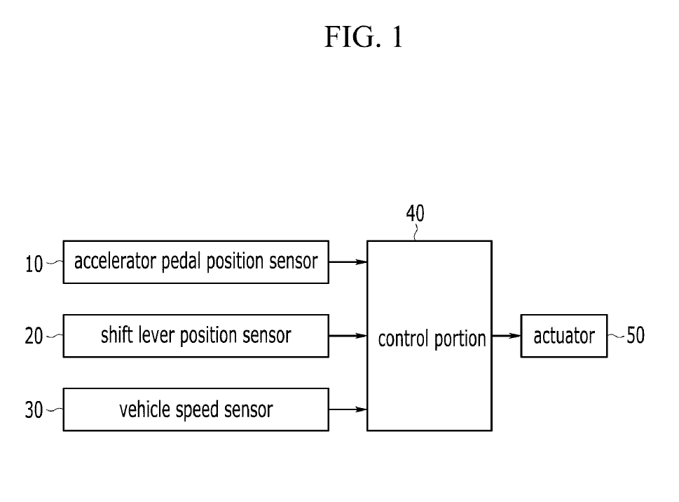

FIG. 1 is a block diagram of a system for controlling vehicle shifting according to various embodiments of the present invention.

As shown in FIG. 1, a system for controlling vehicle shifting according to various embodiments of the present invention includes an accelerator pedal position sensor 10, a shift lever position sensor 20, a vehicle speed sensor 30, a control portion 40, and an actuator 50.

The accelerator pedal position sensor 10 detects a position of an accelerator pedal (e.g., the relative degree of accelerator pedal movement) and delivers a signal corresponding thereto to the control portion 40. If the accelerator pedal is completely pushed the position of the accelerator pedal is 100%, and if the accelerator pedal is not pushed the position of the accelerator pedal is 0%. Instead of using the accelerator pedal position sensor 10, throttle valve opening sensor installed at an intake passage may be used.

The shift lever position sensor 20 detects a position of a shift lever and delivers a signal corresponding thereto to the control portion 40. The position of the shift lever may be P, R, N, or D range or sport mode.

The vehicle speed sensor 30 is mounted at a wheel of the vehicle, detects vehicle speed, and delivers a signal corresponding thereto to the control portion 40.

The position of the accelerator pedal, the position of the shift lever, and the vehicle speed are included in a control parameter. In addition, the control parameter may further include various parameters such as a temperature of transmission fluid, an ambient temperature, a cabin temperature, and so on.

The control portion 40 controls shifting by using various control parameters. For example, if the position of the accelerator pedal with respect to the vehicle speed is higher than or equal to a predetermined value, upshift is performed. If the position of the accelerator pedal with respect to the vehicle speed, on the contrary, is lower than or equal to a predetermined value, downshift is performed.

In addition, the control portion 40 calculates a position change of the accelerator pedal from the position of the accelerator pedal. The position change of the accelerator pedal may be calculated by dividing difference between positions of the accelerator pedal for a predetermined time by the predetermined time. Such the position change of the accelerator pedal may be included in the various control parameters.

In addition, the control portion 40 determines by using the control parameter whether a shift pattern conversion condition is satisfied, and performs conversion of shift pattern when the shift pattern conversion condition is satisfied.

The actuator 50 selectively supplies hydraulic pressure to a plurality of friction elements installed in an automatic transmission so as to perform shift. Solenoid valves may be used as such an actuator 50.

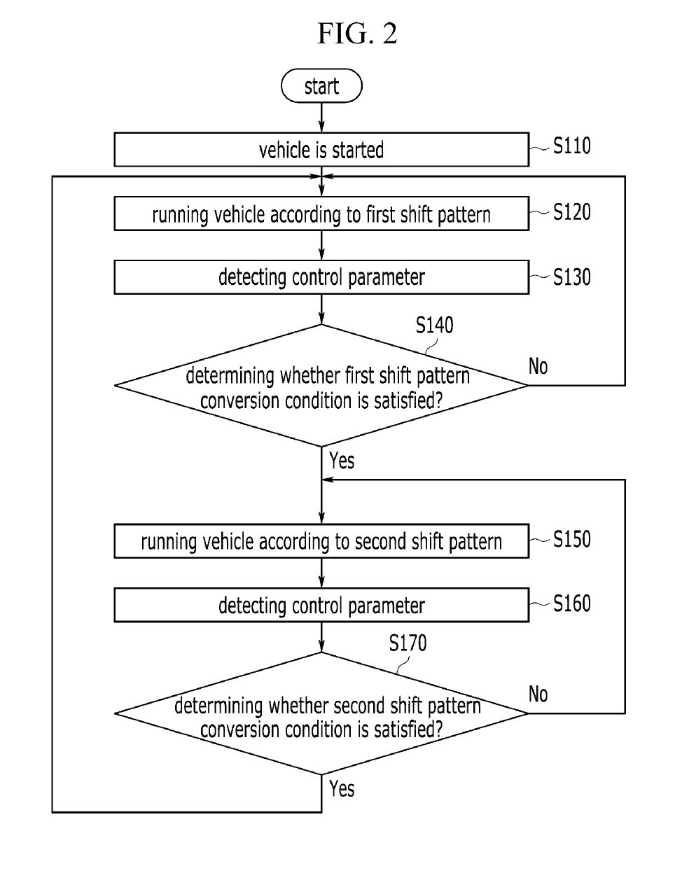

FIG. 2 is a flowchart of a method for controlling vehicle shifting according to various embodiments of the present invention.

As shown in FIG. 2, if the vehicle is started at a step S110, the control portion 40 runs the vehicle according to a first shift pattern at a step S120. The first shift pattern may be a fuel economy oriented shift pattern. That is, the control portion 40 runs the vehicle according to the fuel economy oriented shift pattern basically.

At this state, the control portion 40 detects the control parameter by using the accelerator pedal position sensor 10, the shift lever position sensor 20, and the vehicle speed sensor 30 at a step S130. As described above, the control parameter includes the position of the accelerator pedal, the position of the shift lever, the vehicle speed, and the position change of the accelerator pedal.

After that, the control portion 40 determines whether the various control parameters satisfy a first shift pattern conversion condition at a step S140. That is, if it is determined that the driver likely desires acceleration, the control portion 40 changes the shift pattern from the first shift pattern to a second shift pattern. The second shift pattern may be an acceleration oriented shift pattern. The first shift pattern conversion condition may be satisfied when the position of the accelerator pedal is larger than or equal to a predetermined position and the position change of the accelerator pedal is larger than or equal to a predetermined position change. For example, the predetermined position may be 25%, and the predetermined position change may be 100%/sec.

If the first shift pattern conversion condition is not satisfied at the step S140, the control portion 40 returns to the step S120 and runs the vehicle according to the first shift pattern continuously.

If the first shift pattern conversion condition is satisfied at the step S140, the control portion 40 runs the vehicle according to the second shift pattern at a step S150. That is, the vehicle is run according to the shift pattern which can improve acceleration performance.

At this state, the control portion 40 detects the control parameter by using the accelerator pedal position sensor 10, the shift lever position sensor 20, and the vehicle speed sensor 30 at a step S160.

After that, the control portion 40 determines whether the control parameter satisfy a second shift pattern conversion condition at a step S170. That is, if it is determined that the driver likely does not desire for acceleration, the control portion 40 changes the shift pattern from the second shift pattern to the first shift pattern, and aims to improve fuel economy. The second shift pattern conversion condition is satisfied when the vehicle is stopped, or the position of the shift lever is P, R, or N range.

If the second shift pattern conversion condition is not satisfied at the step S170, the control portion 40 returns to the step S150 and runs the vehicle according to the second shift pattern.

If the second shift pattern conversion condition is satisfied at the step S170, the control portion 40 returns to the step S120 and runs the vehicle according to the first shift pattern.

The step S120 to the step S170 are continuously repeated during the vehicle runs.

Meanwhile, if the shift pattern is changed frequently, the shift may occur frequently and fuel economy may be deteriorated. Therefore, the shift pattern conversion conditions may be strictly set.

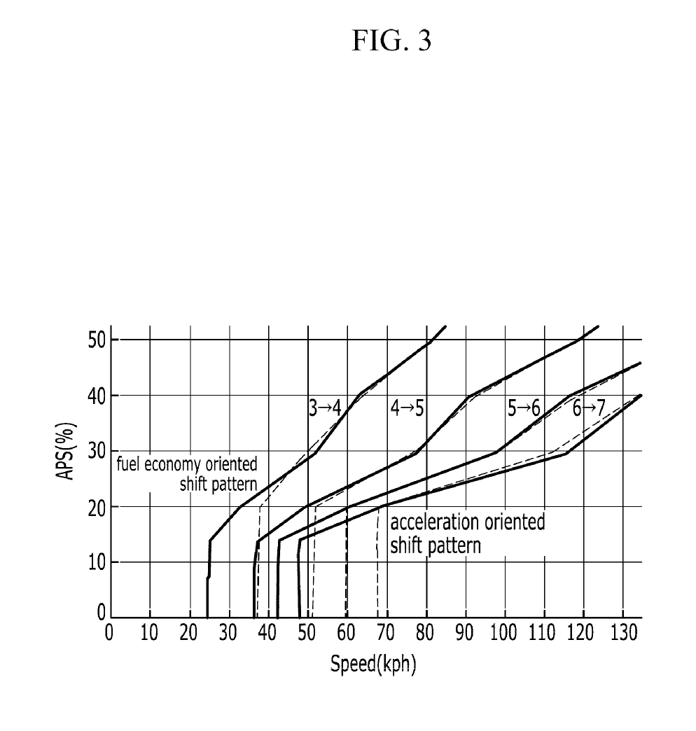

FIG. 3 illustrates comparison of a fuel economy oriented shift pattern and an acceleration oriented shift pattern.

For better comprehension and ease of description, only upshift lines are illustrated in FIG. 3. Downshift lines may be similarly set to the upshift lines. In FIG. 3, a solid line represents the upshift line of the fuel economy oriented shift pattern and a dotted line represents the upshift line of the acceleration oriented shift pattern.

As shown in FIG. 3, if the position of the accelerator pedal is high (e.g., higher than or equal to 20%), the upshift line of the fuel economy oriented shift pattern is similar to that of the acceleration oriented shift pattern. However, if the position of the accelerator pedal is low (e.g., lower than 20%), the upshift line of the acceleration oriented shift pattern is positioned at higher speed than that of the fuel economy oriented shift pattern. Therefore, if the vehicle is run according to the acceleration oriented shift pattern, shift occurs at higher vehicle speed. Therefore, driving torque may be large and acceleration feel may be improved. For example, a minimum vehicle speed at which shift to a seventh forward speed according to the acceleration oriented shift pattern is about 68 km/h (in a case of the fuel economy oriented shift pattern, about 48 km/h).

As described above, since shift pattern is changed into an acceleration oriented shift pattern according to a driver's shifting habits and a vehicle is run according to the acceleration oriented shift pattern, acceleration feel may be improved according to various embodiments of the present invention.

In addition, since the vehicle is run basically according to a fuel economy oriented shift pattern, deterioration of fuel economy may be prevented.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for controlling vehicle shifting, comprising:
running the vehicle according to a first shift pattern;
detecting control parameters;
determining whether the detected control parameters satisfies a first shift pattern conversion condition; and
running the vehicle according to a second shift pattern when the first shift pattern conversion condition is satisfied.

2. The method of claim 1, wherein the first shift pattern conversion condition is satisfied when a position value of an accelerator pedal is larger than or equal to a predetermined position value, and a position change of the accelerator pedal is larger than or equal to a predetermined position change.

3. The method of claim 1, further comprising:
detecting the control parameters during running the vehicle according to the second shift pattern;
determining whether the detected control parameter satisfies a second shift pattern conversion condition; and
running the vehicle according to the first shift pattern when the second shift pattern conversion condition is satisfied.

4. The method of claim 3, wherein the second shift pattern conversion condition is satisfied when the vehicle is stopped or a position of a shift lever is P, R, or N range.

5. A system for controlling vehicle shifting, comprising:
an accelerator pedal position sensor detecting a position of an accelerator pedal;
a shift lever position sensor detecting a position of a shift lever;
a vehicle speed sensor detecting a vehicle speed; and
a control portion operatively connected to the accelerator pedal position sensor, the shift lever position sensor, and the vehicle speed sensor, the control unit controlling vehicle shifting;
wherein the control portion runs the vehicle according to a first shift pattern at an initial state, and runs the vehicle according to a second shift pattern when a first shift pattern conversion condition is satisfied.

6. The system of claim 5, wherein the first shift pattern conversion condition is satisfied when a position value of an accelerator pedal is larger than or equal to a predetermined position value, and a position change of the accelerator pedal is larger than or equal to a predetermined position change.

7. The system of claim 5, wherein the control portion runs the vehicle according to the first shift pattern when a second shift pattern conversion condition is satisfied during running the vehicle according to the second shift pattern.

8. The system of claim 7, wherein the second shift pattern conversion condition is satisfied when the vehicle is stopped or a position of a shift lever is P, R, or N range.
